(19) United States
(12) Patent Application Publication
(10) Pub. No.: US 2023/0400845 A1
(43) Pub. Date: Dec. 14, 2023

(54) HARDWARE RELIABILITY MONITORING AND PREDICTION BASED ON MACHINE LEARNING

(71) Applicant: Rockwell Automation Technologies, Inc., Mayfield Heights, OH (US)

(72) Inventors: Yujia Cui, Cedarburg, WI (US); Jiangang Hu, Mequon, WI (US); Rangarajan Tallam, Germantown, WI (US); Robert J. Miklosovic, Chardon, OH (US)

(73) Assignee: Rockwell Automation Technologies, Inc., Mayfield Heights, OH (US)

(21) Appl. No.: 17/839,004

(22) Filed: Jun. 13, 2022

(51) Int. Cl. G05B 23/02

(52) U.S. Cl. CPC G05B 23/0283

(57) ABSTRACT

An industrial system and a method including using a processor, estimating a reliability of a component of an industrial system using a prognostic model program, using the processor, updating weighting vector parameters of the prognostic model program based on collected data and a previous reliability estimate using machine learning, and using the processor, selectively generating a warning based on comparison of the reliability with a threshold and/or deviation of weighting vector parameters.

### BACKGROUND INFORMATION

Predictive maintenance systems use a fixed equation with preset constant parameters to estimate component degradation and predict reliability or remaining useful lifetime. However, the lifetime prediction accuracy is unverified and cannot capture degradation profile change to ensure in-time alert for check and maintenance. Traditional lifetime prediction method deals with different components separately with different models.

### BRIEF DESCRIPTION

In one aspect, an industrial system includes an inverter, and electronic memory, and a processor. The inverter has an output configured to drive a motor load, and the electronic memory stores data and program instructions. The processor executes the program instructions to control the inverter, to estimate a reliability of a component of the industrial system using a prognostic model program, to update weighting vector parameters of the prognostic model program based on collected data and a previous reliability estimate using machine learning, and to selectively generate a warning based on comparison of the reliability with a threshold.

In another aspect, a method includes, using a processor in individual ones of successive update steps, estimating a reliability of a component of an industrial system using a prognostic model program, updating weighting vector parameters of the prognostic model program based on collected data and a previous reliability estimate using machine learning, and selectively generating a warning based on comparison of the reliability with a threshold.

In a further aspect, a non-transitory computer readable medium has computer executable instructions which, when executed by a processor, cause the processor to estimate a reliability of a component of an industrial system using a prognostic model program, update weighting vector parameters of the prognostic model program based on collected data and a previous reliability estimate using machine learning, and selectively generate a warning based on comparison of the reliability with a threshold.

### BRIEF DESCRIPTION OF THE DRAWINGS

FIG. 1 is a schematic diagram of a motor drive industrial system with a prognostic model.

FIG. 1A is a schematic diagram of a prognostic model as well as sensed and computed values.

FIG. 2 is a flow diagram of a method of estimating component reliability.

FIGS. 3A-3I are graphs of simulated reliability estimates for an example prognostic model program with weighting vector parameters individually associated with three respective predictors using data of different window sizes of different long, medium and long durations.

FIG. 3J is a graph of weighting vector parameters with changes with three example predictors of the prognostic model program updated over eight example iterations.

FIG. 3K is a table of weighting vector parameters with three example predictors of the prognostic model program updated over eight example iterations.

FIG. 4A is a graph of on-state resistance Rdsₒₙ aging data of a MOSFET of the industrial system of FIG. 1 as a function of time.

FIG. 4B is a graph of derived reliability aging data of the MOSFET of the industrial system of FIG. 1 as a function of time based on the results shown in FIG. 4A.

FIGS. 4C-4J are graphs of MOSFET reliability estimates for an example prognostic model program with weighting vector parameters individually associated with three respective predictors of different long, medium and short durations for eight example step iterations.

FIG. 4K is a graph of weighting vector parameter deviation with three example predictors of the prognostic model program updated over eight example iterations.

### DETAILED DESCRIPTION

Referring now to the figures, several embodiments or implementations are hereinafter described in conjunction with the drawings, wherein like reference numerals are used to refer to like elements throughout, and wherein the various features are not necessarily drawn to scale. Components of electrical systems, such as industrial systems with power converters and other electrical machines, age over time and performance degrades. Detecting component degradation helps identify component and system level reliability as an aid to preventative maintenance and prognostic reliability estimation helps reduce system down time. Described examples provide motor drives and other industrial systems, as well as methods and computer-readable mediums to assess overall component reliability at a manufacturing facility or other industrial equipment installation with machine learning to update weighting vector parameters of a prognostic model program based on collected data and a previous reliability estimate.

The described examples provide an intelligent solution to the inability of conventional lifetime prediction to accurately quantify degradation profile change and ensure in-time alert for check and maintenance. In certain examples, a motor drive power converter provides on-board prognostic reliability determination with alarms and/or warnings or other indications (e.g., output parameters to a customer or connected system) of electrical component health to a user, such as through a network or a user interface, for example regarding estimated remaining component or system lifetime, mean time between failure (MTBF) information, percent consumed life, or the like, which may be triggered by threshold conditions associated with estimated reliability of one or more electrical components in the industrial system. The described examples use reliability-based programs with algorithms implemented by a system processor, whether in a motor drive or other industrial system, and/or in an on-site or remote network server or another network element. Moreover, the described systems and techniques can be employed in a variety of industrial equipment beyond power conversion systems to estimate and track cumulative component reliability for many different applications, including without limitation adaptive maintenance scheduling to mitigate or avoid unscheduled system downtime.

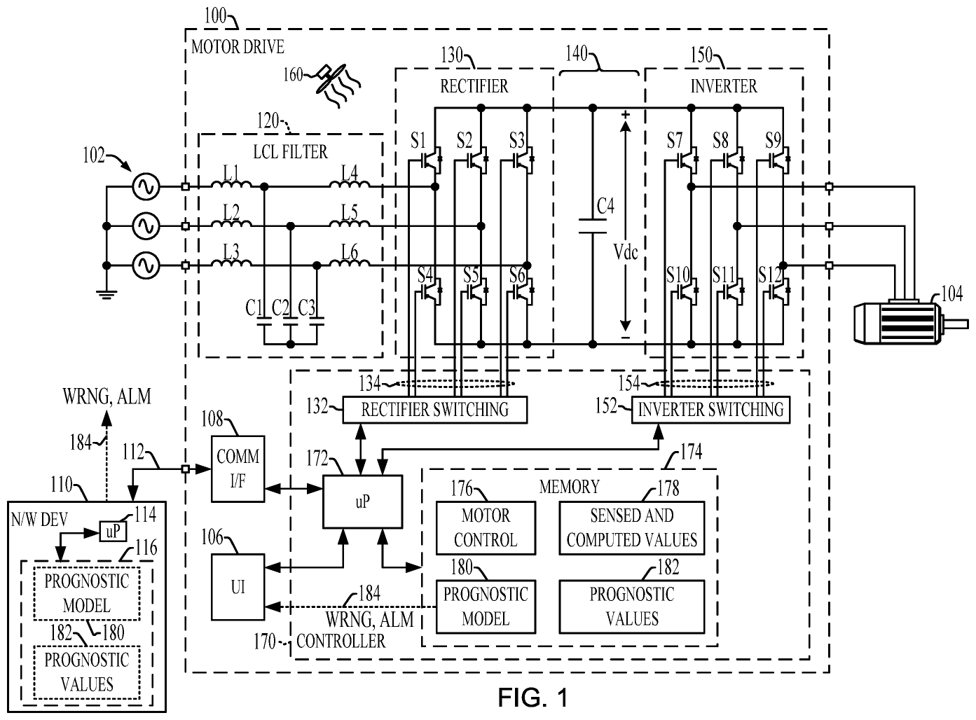

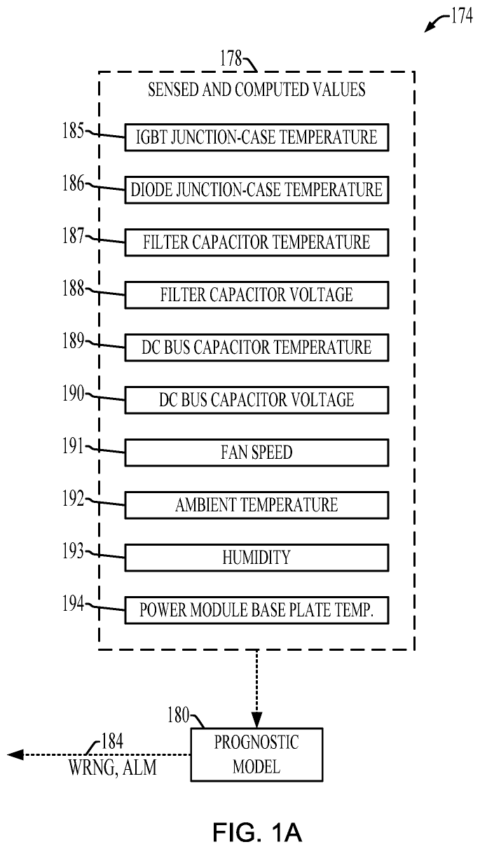

FIG. 1 illustrates an example electrical industrial system to convert electrical power to drive a load. The example system includes a motor drive power converter industrial system 100 configured or otherwise adapted to receive single or multiphase AC input power from an external power source 102. Although illustrated and described in the context of a motor drive, disclosed examples find utility as a general algorithm that can be used on any industrial components or systems. The illustrated example receives a three-phase input. In other examples, single phase or other multiphase embodiments are possible. The industrial system 100 converts input power from the source 102 to deliver output power to drive a motor load 104. The industrial system 100 includes a three phase LCL input filter circuit 120 having grid side inductors L1, L2 and L3 connected to the power leads of the power source 102, series connected converter side inductors L4, L5 and L6, and filter capacitors C1, C2 and C3 connected between the corresponding grid and converter side inductors and a common connection node, which may but need not be connected to a system ground. The industrial system 100 also includes a rectifier 130, a DC bus or DC link circuit 140, an output inverter 150 and a fan 160 to circulate air within a drive enclosure (not shown) for cooling one or more system electrical components.

The rectifier 130 and the inverter 150 are operated by a controller 170. The controller 170 includes a processor 172, an electronic memory 174 that stores data and program instructions, as well as a rectifier controller 132 and an inverter controller 152. The controller 170 and the components thereof may be implemented as any suitable hardware, processor-executed software, processor-executed firmware, logic, and/or combinations thereof wherein the illustrated controller 170 can be implemented largely in processor-executed software or firmware providing various control functions by which the controller 170 receives feedback and/or input signals and/or values (e.g., setpoint(s)) and provides respective rectifier and inverter switching control signals 134 and 154 to operate switching devices S1-S6 of the rectifier 130 and switches S7-S12 of the inverter 150 to convert input power for providing AC output power to drive the load 104. In addition, the controller 170 and the components 132, 152 thereof can be implemented in a single processor-based device, such as a microprocessor, microcontroller, FPGA, etc., or one or more of these can be separately implemented in unitary or distributed fashion by two or more processor devices.

The industrial system 100 in one example provides an active front end (AFE) including a switching rectifier (also referred to as a converter) 130 receiving three-phase power from the source 102 through the filter circuit 120. The active rectifier 130 includes rectifier switches S1-S6, which may be insulated gate bipolar transistors (IGBTs) or other suitable form of semiconductor-based switching devices operable according to a corresponding rectifier switching control signal 134 to selectively conduct current when actuated. In addition, diodes are connected across the individual IGBTs S1-S6. In operation, switching of the rectifier switches S1-S6 is controlled according to pulse width modulated rectifier switching control signals 134 from the rectifier switching controller 132 to provide active rectification of the AC input power from the source 102 to provide a DC bus voltage Vdc across a DC bus capacitor C4 in the DC link circuit 140. The inverter 150 includes switches S7-S12 coupled to receive power from the DC bus 140 and to provide AC output power to a motor or other load 104. The inverter switches S7-S12 can be any form of suitable high-speed switching devices, including without limitation IGBTs that operate according to switching control signals 154 from the inverter switching control component 152 of the drive controller 170.

In certain examples, the controller 170 receives various input signals or values, including setpoint signals or values for desired output operation, such as motor speed, position, torque, etc., as well as feedback signals or values representing operational values of various portions of the industrial system 100 and electrical system components of the industrial system 100. For example, the drive 100 includes various sensors (not shown) to provide sensor signals to the controller 172 indicate operating conditions of one or more components in the drive system 100, including thermocouples, RTDs or other temperature sensors to provide signals or values to the controller 170 indicating the temperatures of the switches S1-S12, the filter and DC bus capacitors C1-C4, ambient temperature(s) associated with the interior of the industrial system enclosure, such as a local temperature around (e.g., proximate) fan, voltages associated with one or more components (e.g., voltages associated with the switches S1-S12, voltages across the capacitors C1-C4), operating speed (rpm) of the fan 160, etc. In addition, the controller 170 in certain examples receives one or more voltage and/or current feedback signals or values from sensors to indicate the DC bus voltage Vdc, line to line AC input voltage values, motor line to line voltage values and/or currents, etc. In certain examples, the system 100 also includes one or more humidity or moisture sensors to sense ambient humidity within an enclosure, although not a strict requirement of all possible implementations.

The controller 170 in one example receives and stores this information as sensed and computed values 178 in the memory 174. The stored values 178 can include values computed by the processor 172 based on one or more sensor signals or values, such as temperature change values (e.g., ΔT) representing the temperature of a component relative to the ambient temperature of the drive enclosure. The sensed and computed values 178 in one example are obtained or updated periodically by the processor 172, and the controller 170 includes suitable sensor interface and/or communications circuitry to receive sensor signals and/or digital values from sensors in the drive system 100. In certain implementations, the processor 172 uses all or some of this information 178 to perform closed loop control of the operation of the motor load 104 by execution of motor control program instructions 176 stored in the memory 174, such as speed control, torque control, etc.

In addition, the controller 170 in certain examples implements prognostic functions by executing program instructions 180 to estimate reliability of one or more electrical system components of the industrial system 100. In addition, the memory 174 stores one or more prognostic values 182, such as reliability estimates, weighting values, deviation values, etc. The processor 172 in one example implements the prognostic model program instructions 180 to estimate electrical component reliability and selectively generate one or more alarm and/or warning signals or messages 184 to identify reliability of one or more electrical components to a user and/or to a connected system.

As shown in the example of FIG. 1, the processor 172 is operatively coupled with a user interface (UI) 106, such as a touchscreen or other user interface associated with the motor drive industrial system 100. In certain examples, the control processor 172 provides one or more warnings and/or alarms 184 to the user interface 106 to alert the user to certain threshold conditions associated with one or more electrical components in the drive 100. Separately or in combination, the control processor 172 in certain implementations provides the warnings and/or alarms 184 as input information or input data to a maintenance scheduling system, for example, in a connected network element (not shown). The described examples extend the capabilities of predictive maintenance by updating weighting vectors of the prognostic model program 180 based on collected data and a previous reliability estimate using machine learning.

The described systems and techniques can use chemical, temperature, and humidity sensors to provide the environmental inputs as well as data analytics and visualization to track environmental conditions and rates of component degradation or life consumption for industrial products and systems implemented in an industrial site. The described examples facilitate adaptation of maintenance scheduling to account for degrading effects on electrical components, such as fan component wear, transistor on-state resistance change, etc.

In certain examples, moreover, the control processor 172 is operatively coupled with one or more network devices 110 via a communications interface 108 and a network connection 112, which can be wired, wireless, optical or combinations thereof. In certain examples, the controller 170 provides one or more of the sensed and/or computed values 178 to the network device 110 via the communications interface 108 and the network 112, and the network device 110 includes a processor 114 and a memory 116 to implement the prognostic model program instructions 180 and to store the prognostic values 182. In practice, any suitable processor can implement the reliability estimation concepts disclosed herein, whether an on-board processor 172 of the motor drive controller 170 or the processor 114 of the network device 110. In certain examples, the network device 110 can be a network server implementing the prognostic model 180 as program instructions for execution by the server processor 114. In another example, the network device 110 can be a process control device, such as a control module in a distributed control system (DCS), and the communications interface 108 and the network 112 can be a network of a DCS for exchanging values and messages (e.g., sensed and/or computed values 178) between the industrial system 100 and the control module 110.

The processor implemented prognostic model 180 operates on one or more sensed and/or computed values 178 stored in the memory 174. In certain examples, moreover, the model 180 uses values programmed by a user or configured based on user input. The operation of the prognostic model 180 is described hereinafter in the context of implementation by the control processor 172 via the electronic memory 174 in the drive controller 170. In other examples, the prognostic model 180 is implemented in a network device 110 or other processor-based system in similar fashion (e.g., processor 114 in FIG. 1).

As illustrated in FIG. 1A, the sensed and computed values 178 can be stored for one or more components of the electrical drive system 100 in one example. For example, the values 178 can be saved for the individual rectifier and/or inverter switches S1-S12, the drive capacitor C1-C4 and/or the drive cooling fan 160 in the example of FIGS. 1 and 1A. In one example an IGBT junction-case temperature value 185 is stored in the memory 174 for each of the switches S1-S12. The value(s) may be computed, for example, with the IGBT junction-case temperature 185 being computed from the heat generation in the IGBT and a sensor value from a thermocouple or RTD individually associated with a given one of the switches S1-S12. As shown in FIG. 1A, the sensed and computed values 178 may further include one or more diode junction-case temperatures 186, filter capacitor temperatures 187, filter capacitor voltages 188, DC bus capacitor temperatures 189, DC bus capacitor voltages 190, fan speed value 191, air temperature 192, and power module base plate temperature 194. In certain examples, moreover, the sensed and computed values 178 include one or more humidity values 193.

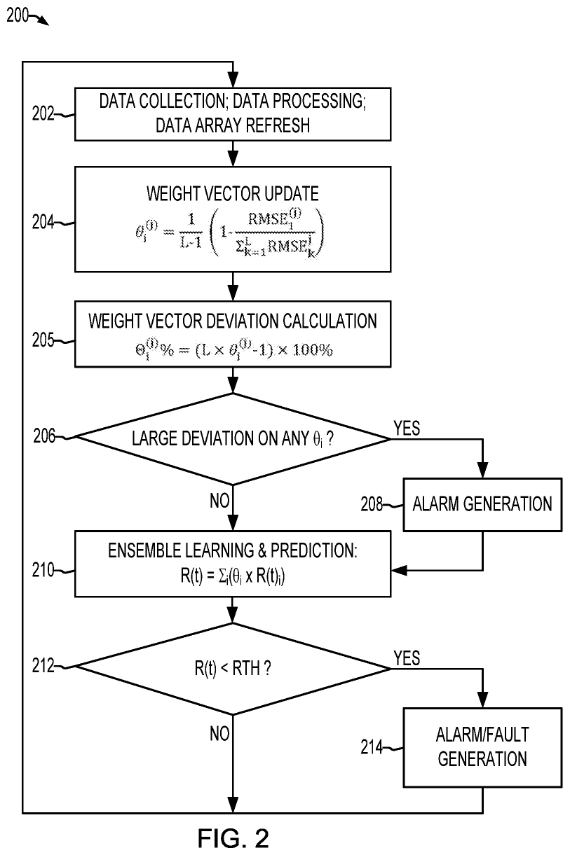

In one implementation, the processor 172 (and/or the processor 114) is configured to execute the program instructions of the prognostic model program 180 to control the inverter 150, to estimate 200 a reliability R(t) of a component (e.g., transistors S1-S12, capacitors C1-C4, fan 160, etc.) of the industrial system 100, and to update weighting vector parameters θi of the prognostic model program 180 based on collected data and a previous reliability estimate using machine learning. In addition, the processor 114, 172 is configured to selectively generate a warning or alarm 184 based on comparison of the reliability R(t) with a threshold RTH as discussed further below in connection with FIG. 2. The processor 114, 172 is configured to update the weighting vector parameters θi of the prognostic model program by a root mean square error RMSE algorithm in one example. In this or another implementation, the weighting factor parameters θi of the prognostic model program are individually associated with a respective predictor of the reliability R(t) of the component S1-S12, C1-C4, 160 of the industrial system 100. In one example, the weighting factor parameters θi of the prognostic model program 180 are of different operating durations of the component of the industrial system 100. In this or another example, the weighting factor parameters θi of the prognostic model program 180 are of different operating frequencies of the component of the industrial system 100. In these or another example, the weighting factor parameters θi of the prognostic model program 180 are of different operating temperatures of the component of the industrial system 100. In these or another example, the weighting factor parameters θi of the prognostic model program 180 are of different operating voltages of the component of the industrial system 100.

Referring also to FIG. 2, the industrial system 100 of FIGS. 1 and 1A implements a method 200 to monitor and predict the reliability (e.g., remaining useful life) of one or more industrial system components or subsystems based on machine learning, and the method 200 can be applied to any hardware component (e.g., electronic components including without limitation IGBTs, MOSFETs, capacitors, fans, etc.) by adjusting related parameters of the prognostic program 180. In operation in one example, the processor 114, 172 executes the instructions of the prognostic program 180 to monitor operating environment changes (e.g., fan failure, temperature increase) and estimates component reliability, and also to generate alerts for in-time check and maintenance, to potentially improve product lifetime. Other predictive maintenance algorithms based on ‘open-loop’ and ‘fixed’ equations from frame rating tables (FRT), or other databases operate without learning and adjustment capability. The prognostic program 180 in the illustrated examples provides the capability to learn from observed data with machine learning and generates more accurate prediction. In various implementations, the machine learning adaptive updating of weighting parameters of the prognostic program 180 can be implemented on different levels based on application, such as drive level, programmable logic controller (PLC) level, edge device level, cloud level, etc.

Remaining useful lifetime prediction helps to schedule preventive maintenance and reduce overall cost by mitigating or avoiding unexpected system shutdowns. In addition to remaining lifetime prediction, the prognostic program 180 can provide real-time operating condition monitoring to improve the overall lifetime, for example, notifying a user that changed environmental and/or operating conditions are accelerating component degradation. Moreover, while traditional lifetime prediction methods deal with different components separately with different models, the prognostic program 180 provides a unified algorithm to cover most of the hardware components of an industrial system.

In one implementation, the prognostic model program 180 provides reliability models for individual components based on a Weibull distribution as an analysis base. For example, individual component models are implemented to collect important indicator variables (e.g., resistance, temperature, voltage, etc.) as input data to the prognostic model program 180. In one example implementation, multiple predictors of different durations (e.g., with different window sizes) can be trained and combined with weighting vector parameters θᵢ of the prognostic model program 180. The number of predictors (e.g., an integer L) can be adjusted by user based on application/product.

FIG. 2 illustrates an example method 200 for one of a number of successive update steps. In one implementation, the method 200 operates in a continuous loop with successive update steps, beginning with data collection, data processing, and data array refreshing at 202. The method 200 includes estimating a reliability R(t) of a component (e.g., S1-S12, C1-C4, 160) of the industrial system 100 using the prognostic model program 180, and the illustrated method 200 is performed for each component model of the monitored industrial system 100.

In one example, the processing at 202 includes acquiring sensed values, computing any data values there from, and storing the sensed and computed values 178 in the memory 174 (e.g., FIGS. 1 and 1A above). In an implementation of the prognostic model program 180 by the local processor 172 of the motor drive industrial system 100, the processing at 202 can also include sending processed data 178 to an external network device 110 via the communications interface 108. This implementation facilitates economized local memory storage in the memory 174, as well as economized data transfer via the communications interface 108 since the network device 110 need not store all the previously obtained sensed values, allowing the local processor 174 to generate actionable information (e.g., current operating conditions and reliability estimates) without overloading the external network device 110. For example, an integer number L predictors for a given component reliability estimation may utilize a respective integer number of samples for regression computations (e.g., where the number of samples may be different for weighting factor parameters θi of different operating durations of the component S1-S12, C1-C4, 160 of the industrial system 100, and the sensed and computed values 178 of the local memory 174 only required the respective integer number of samples, and earlier samples can be removed from the local memory 174 at 202 in FIG. 2, thereby conserving the amount of storage in the local memory 174.

At 204 in FIG. 2, the weighting factor parameters θi of a weighting vector θ of the prognostic model program 180 are updated based on collected data and a previous reliability estimate using machine learning. In the illustrated example, “L” is an integer number greater than 1 that represents the number of predictors, the index “i” represents an integer number that increments from 1 through L for evaluation of an integer number L weighting factor parameters θi of the prognostic model program 180 (e.g., where Σθi=1), and “j” is an integer number indicating the current update step. In one example, the processing at 204 includes updating the weighting vector parameters θi according to the following equations (1), (2), and (3). For each update step or time “t” of a matrix “T” of different times t and respective step numbers “j”, the weighting vector θ includes the respective weighting factor parameters θi of the prognostic model program 180 as shown in equation (1). The updates weighting factor parameters θi of next step (e.g., j+1) are computed according to the equation (2). In one example, the processing at 204 includes updating the weighting vector parameters θi of the prognostic model program by a root mean square error (RMSE) algorithm according to equation (3), where θ^{(j)} is the weighting vector at step j, θᵢ^{(j)} is the updated weight parameter for predictor i at step j, RMSEᵢ^{(j)} is the root mean square (RMS) error for predictor i at step j, yₖ^{(j)} is the measured k-th new data point at step j, and R(t)ᵢₖ^{(j)} is the predicted k-th data point at step j.

$$( 1 ) {θ}^{j} = {[ {θ}_{1}^{( j )} , {θ}_{2}^{( j )} , … , {θ}_{L}^{( j )} ]}^{T} \\ ( 2 ) {θ}_{i}^{( j + 1 )} = \frac{1}{L - 1} ( 1 - \frac{{RMSE}_{i}^{( j )}}{{\sum }_{k = 1}^{L} {RMSE}_{k}^{( j )}} ) \\ ( 3 ) {RMSE}_{i}^{( j )} = \sqrt{\frac{{\sum }_{k = 1}^{N} {( {y}_{k}^{( j )} - {R ( t )}_{ik}^{( j )} )}^{2}}{N}}$$

The weighting factor parameter updating at 204 in one example uses three predictors of different durations with associated weighting factor parameters (e.g., L=3) including a long-window predictor (e.g., using the most recent 45 sample points) to facilitate consistency and stability, a medium-window predictor (e.g., using the most recent 30 sample points), and a short-window predictor (e.g., using the most recent 15 sample points) to capture degradation profile changes more quickly. In one example, the data sampling is at the same rate as the update steps, although not a strict requirement of all possible implementations, and the weighting vector θ is updated at each step j. In this example, moreover, RMSE of prediction errors from each predictor is used as penalty when updating θ.

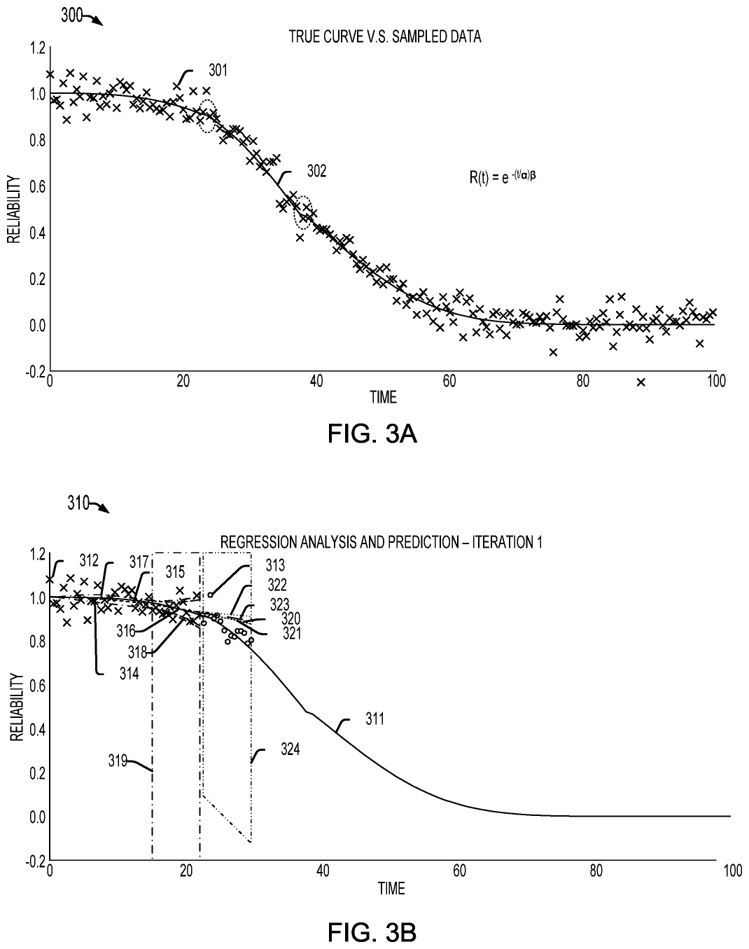

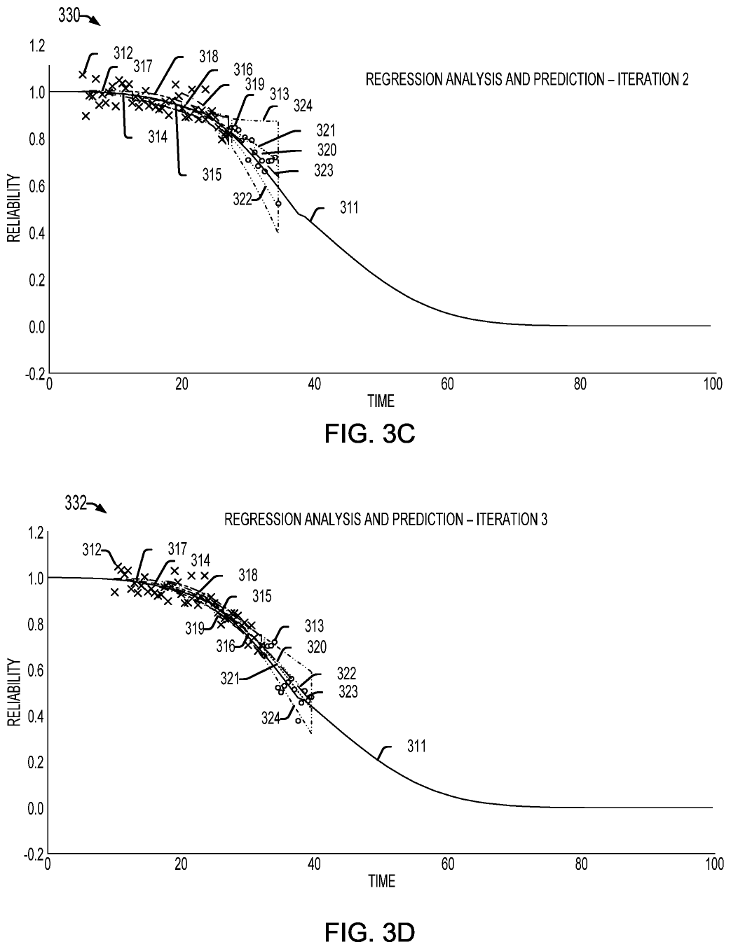

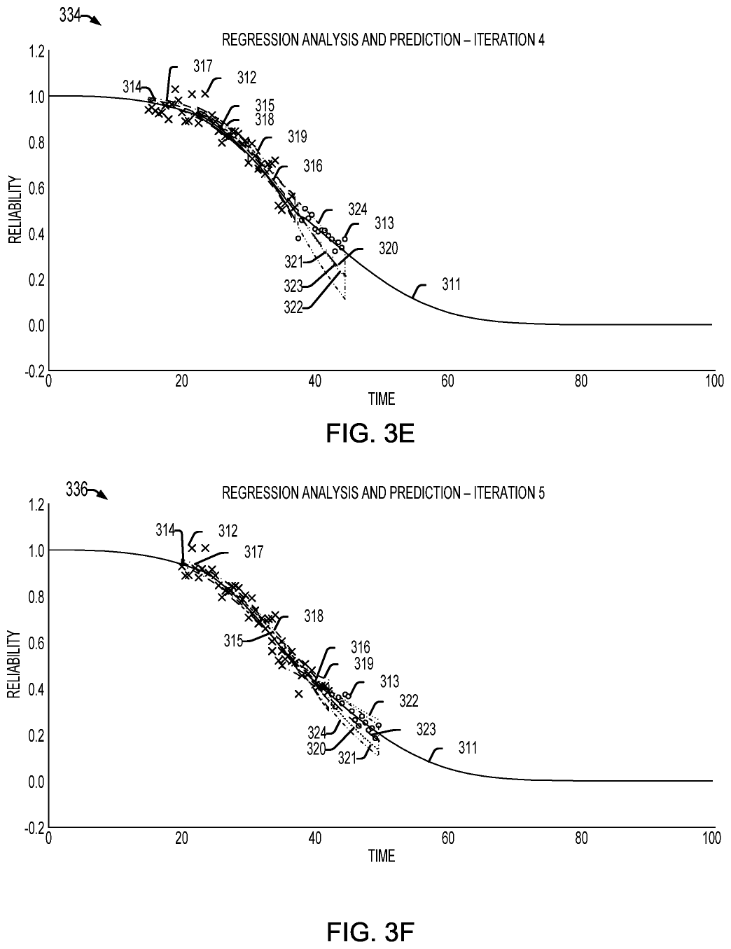

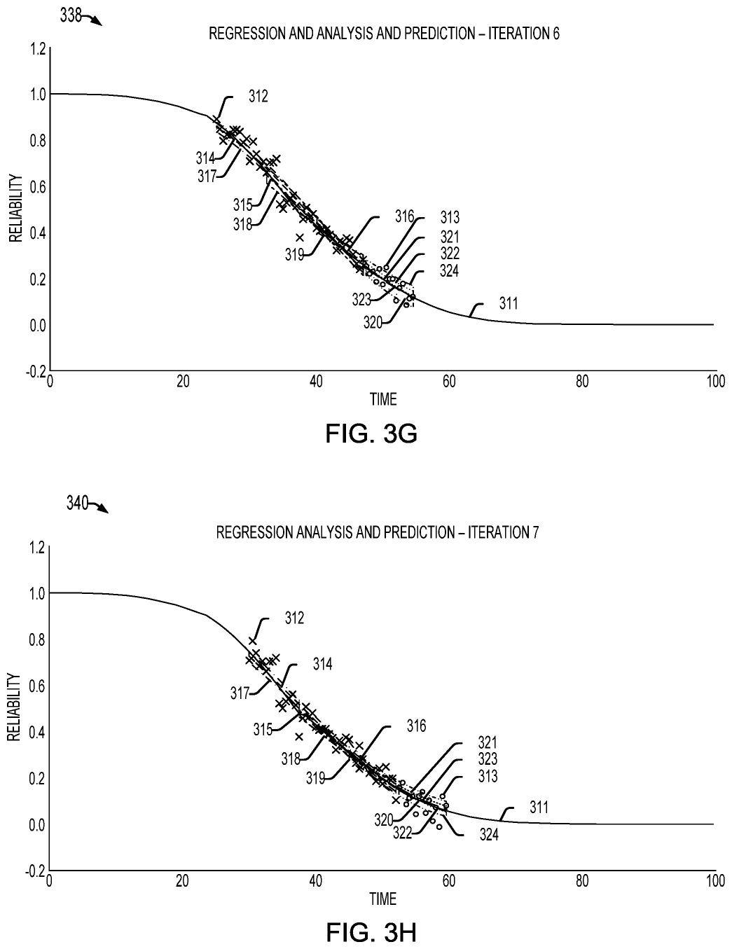

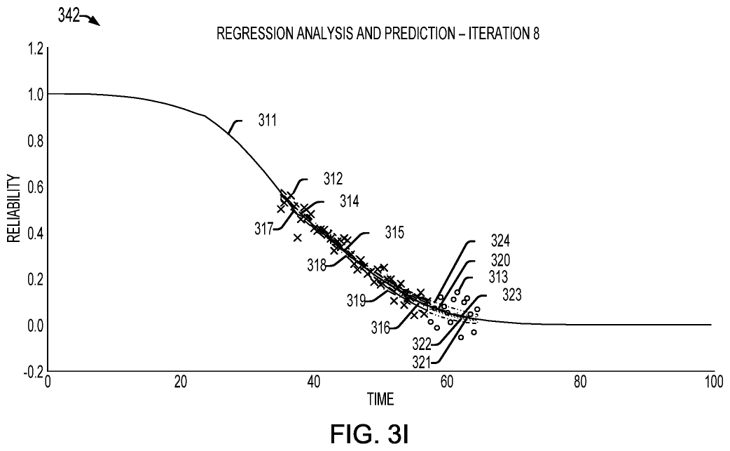

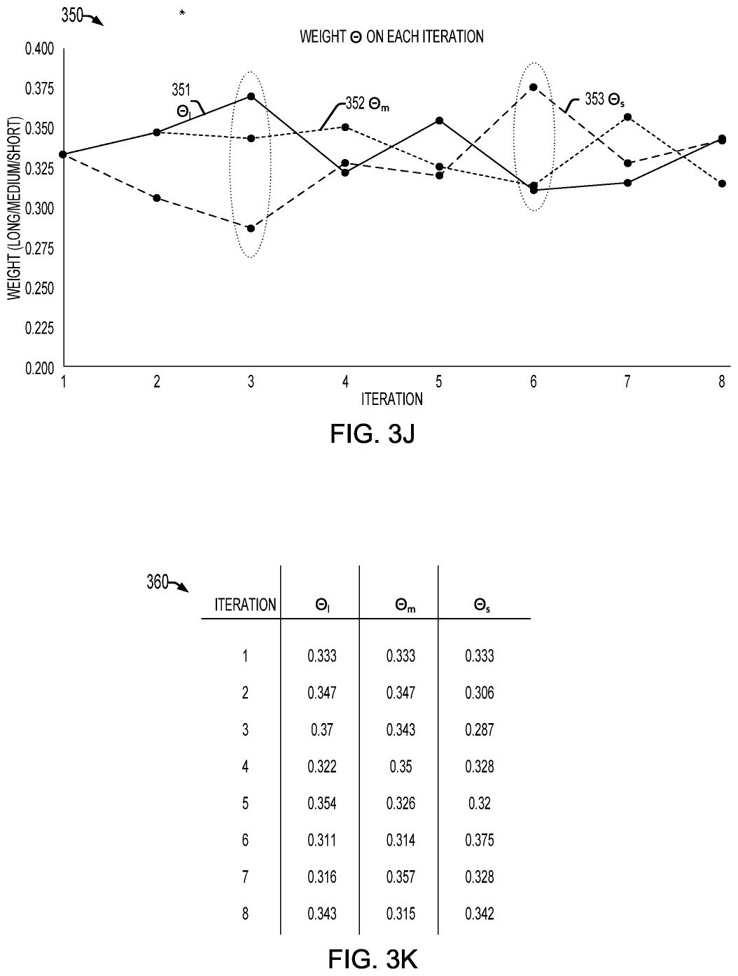

As discussed further below, the prognostic model program 180 starts the algorithm for regression analysis with the weighting vector parameters all equal to one another at a value of 1/L (e.g., 1/3 in this example), although not a strict requirement of all possible implementations. As the algorithm progresses through successive update steps j, the weighting vector parameters θi are updated at 204, and the respective values may deviate based on accuracy of the resulting predictions (e.g., as illustrated and described further below in connection with FIG. 3J and FIG. 3K). In one implementation, a low sampling rate is enough for reduced cost and computation load, for example, daily or weekly or monthly, depending on the expected degradation rates of the monitored components of the industrial system 100. In one example, the prognostic model program 180 implements filtering on raw measured data (e.g., moving averaging).

In various implementations, the window size for regression analysis and prediction can be changed, and the step size for moving the sliding window can be adjusted. Moreover, the number of predictors in the regression analysis and prediction algorithm can be any suitable values. Furthermore, different predictor aspects can be utilized in these or other examples, where the weighting factor parameters θi of the prognostic model program are individually associated with a respective predictor of the reliability Rt of the component of the industrial system 100. For example, the weighting factor parameters θi of the prognostic model program 180 in the illustrated example are of different operating durations of the component of the industrial system 100. In this or another example, the weighting factor parameters θi of the prognostic model program 180 can be of different operating frequencies of the component of the industrial system 100. In these or other examples, the weighting vector parameters θi of the prognostic model program 180 can be of different operating temperatures of the component of the industrial system 100. In these or further examples, the weighting vector parameters θi of the prognostic model program 180 can be of different operating voltages of the component of the industrial system 100.

At 205 in FIG. 2, the method 200 includes weighting vector deviation calculation to compute a weighting vector deviation vector Θ that includes L individual weighting vector deviation values Θi. Ideally, θi remains 1/L through iterations, but large deviation of any θi indicates degradation profile variation. In one example, the weighting vector deviation values Θi for the update step j are computed according to the following equation (4):

γᵢ^{(j)}%=(L×θᵢ^{(j)}−1)×100% (4)

A determination is made at 206 in FIG. 2 as to whether a threshold amount of deviation has occurred on any of the weighting vector deviation values Θi for the update step j. In one example, the processor 114, 172 compares the individual weighting vector deviation values Θi with a predetermined (e.g., and/or adjustable) deviation threshold (not shown). If one or more of the weighting vector deviation values Θi exceeds the threshold (YES at 206), the processor 114, 172 selectively generates an alarm at 208.

Otherwise (NO at 206), the method 200 continues at 210 with ensemble learning and prediction processing. The illustrated example implements a two-step iteration with regression analysis on collected data and weight vector θ adjustment. Ensembled prediction on of the component reliability is performed at 210 with the weighting vector θ that is consistently updated, with RMSE at 204 of prediction errors as a weighting penalty. The deviation or change of the weighting vector θ is used to monitor operating condition changes, for example by the selective alarm generation at 206, 208. In the illustrated implementation, moreover, the component reliability is predicted with a confidence interval, for example, 95%˜2σ, which can be adjustable for different applications and/or four different analyzed components or component types. The ensemble learning and prediction processing at 210 in one example is implemented according to the following equations (5)-(8). The confidence interval (CI) of a respective update step j is given by equation (5):

CI^{(j)}=R(t)_{combined}^{(j)}+σ_{R}(t)_{combined}^{(j)} (5)

In one example, the processor 114, 172 computes a combined component reliability R(t)_{combined} for the update step j according to equation (6):

R(t)_{combined}^{(j)}=Σᵢ₌₁^{L}θᵢ^{(j)}R(t)ᵢ^{(j)} (6)

The processor 114, 172 in one example computes the standard deviation σ_{R}(t) of the estimated component reliability for the combined multi-predictor regression result for the update step j according to equation (7), and the standard deviation σ_{R}(t)ᵢ for the respective predictors are computed according to the following equation (8) for the update step j:

$$( 7 ) {{σ}_{R} ( t )}_{combined}^{( j )} = {\sum }_{i = 1}^{L} {θ}_{i}^{( j )} {{σ}_{R} ( t )}_{i}^{( j )} \\ ( 8 ) {{σ}_{R} ( t )}_{i}^{( j )} = {t}_{α / 2 , v} \sqrt{{χ}_{v}^{{2}^{( j )}} {\sum }_{m = 0}^{D} {\sum }_{k = 0}^{D} \frac{\partial {R ( t )}_{i}^{( j )}}{\partial {p}_{m}} \frac{\partial {R ( t )}_{i}^{( j )}}{\partial {p}_{k}} {C}_{mk}}$$

The processor 114, 172 in one example computes the estimated component reliability R(t) at 210 according to the following equation (9):

R(t)=Σᵢ(γᵢ×R(t)ᵢ) (9)

At 224, the processor 114, 172 compares the estimated component reliability R(t) to a reliability threshold RTH, and selectively generates a warning based on comparison of the reliability R(t) with the threshold RTH. In one implementation, if the estimated component reliability R(t) is less than the reliability threshold RTH (YES at 212), the processor 114, 172 selectively generates an alarm/fault or other warning at 214.

Referring also to FIGS. 3A-3K, FIGS. 3A-3I show graphs of simulated reliability estimates (e.g., computed R(t) above) for the example prognostic model program 180 with weighting vector parameters θi individually associated with three respective predictors of different long, medium and long durations. FIG. 3A illustrates reliability graph 300 as a function of time that shows sample data 301 and a true reliability curve 302 for an example component reliability R(t)=e^{-(t/α)β}.

FIGS. 3B-3I show respective graphs 310, 330, 332, 334, 336, 338, 340, and 342 of simulated reliability estimates (e.g., computed R(t) above) for the prognostic model program 180 for an example regression through eight iterations or update steps (e.g., J=8) of the method 200 in the industrial system 100. The graphs in FIGS. 3B-3I include a true reliability curve 311, training data points 312, future data points 313, a long-window trained curve 314, a medium-window trained curve 315, a short-window trained curve 316, a trained long-window 95% confidence interval 317, a trained medium 95% confidence interval 318, a trained short 95% confidence interval 319, a long-window predicted reliability curve 320, a medium-window predicted reliability curve 321, a short-window predicted reliability curve 322, a combined predicted reliability curve 323, and a combined predicted 95% confidence interval window 324.

The graph 310 in FIG. 3B illustrates a first iteration (ITERATION 1), and the graphs 330, 332, 334, 336, 338, 340, and 342 in the respective FIGS. 3C-3I show the subsequent second, third, fourth, fifth, sixth, seventh, and eighth iterations. The simulated example begins with the weighting vector parameters θi all=1/L (e.g., θi=1/3), and the weighting vector parameters θi are updated (e.g., at 204 in FIG. 2 above) as the algorithm progresses through successive update steps j.

FIG. 3J shows a graph 350 with a first curve 351 showing a first weighting vector parameter θ₁ that corresponds to the long-window predictor, a second curve 352 that shows a second weighting vector parameter Om that corresponds to the medium-window predictor, and a third curve 353 that shows a third weighting vector parameter θₛ that corresponds to the short-window predictor through the eight update step iterations of FIGS. 3B-3I.

A table 360 in FIG. 3K shows corresponding simulated weighting vector parameter values of the parameters θ₁, θₘ, and θₛ in the respective update step iterations. As shown in the circled update step iterations 3 and 6 in FIG. 3J (and the corresponding values in FIG. 3K), temperature or other environmental change can initiate significant deviation in the component degradation rate, which is manifested by large deviations in one or more of the weighting vector parameters, leading to adaptive updating of the weighting vector parameter values by the processor 114, 172 in executing the program instructions of the prognostic model program 180 by the method 200. This facilitates monitoring and/or identification of degradation profile changes by noticeable variations in the weighting vector parameter values, which can be used to initiate a warning and/or alarm by the processor 114, 172 (and/or can be identified by a connected remote network device such as the network device 110 in FIG. 1 above). In one example, the system generates a warning not just based on comparison with threshold, but also or alternatively if theta of different predictors show high deviation from ideal values or from each other, the system can generate a warning as shown in FIG. 3J.

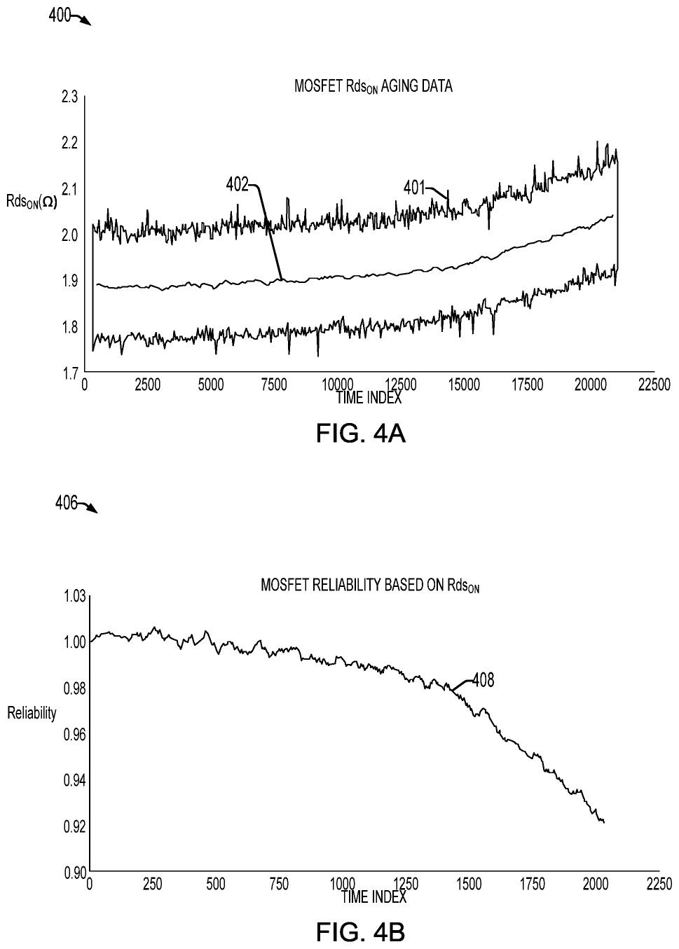

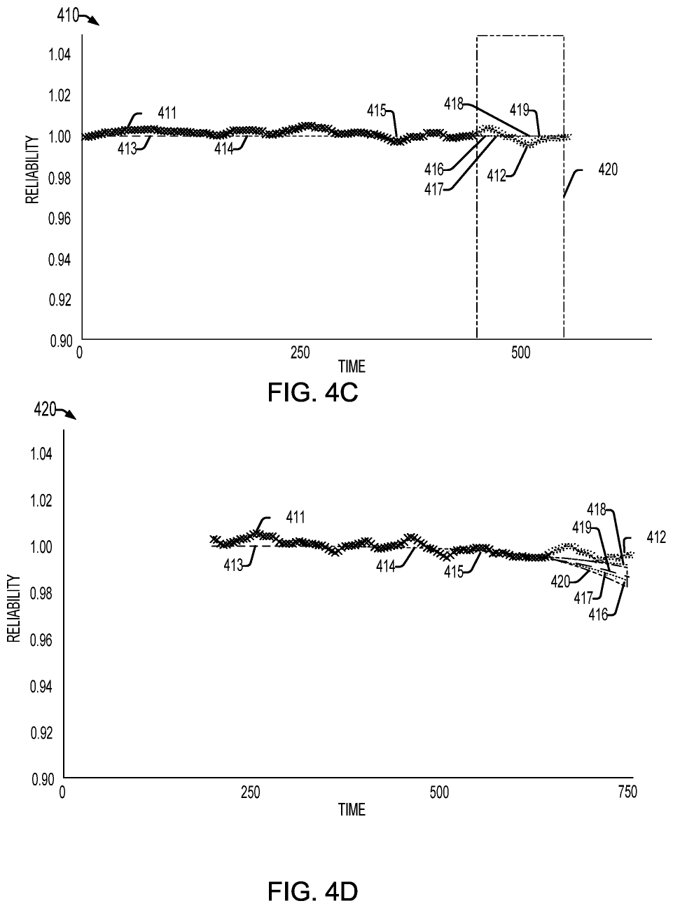

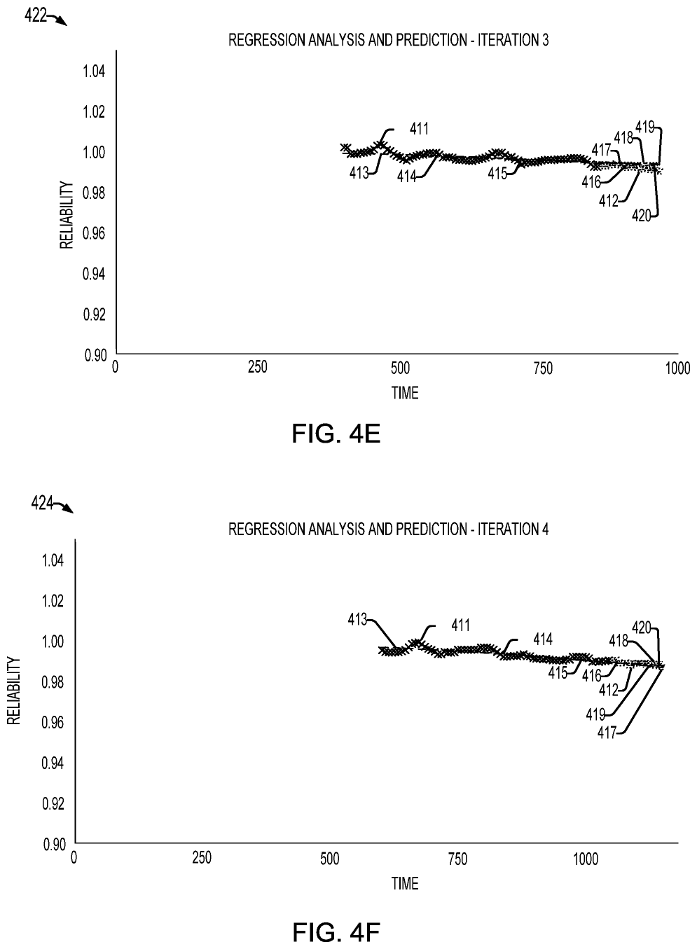

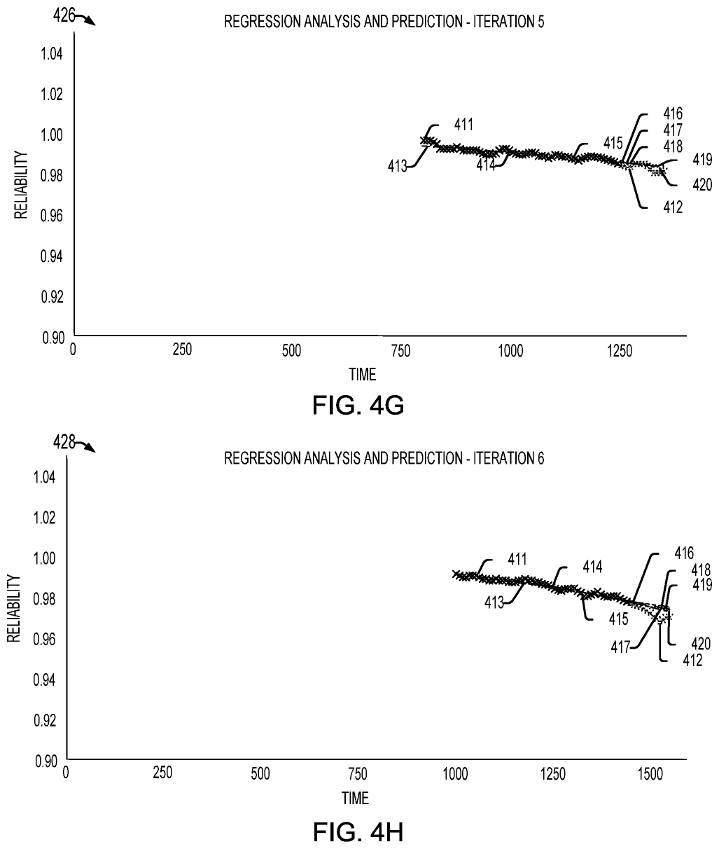

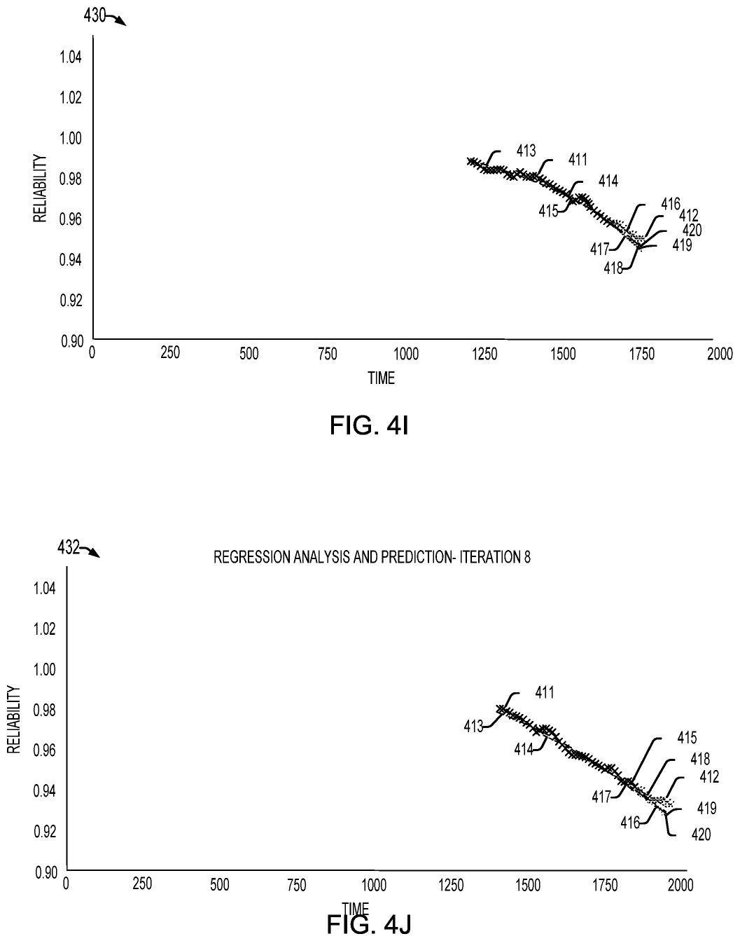

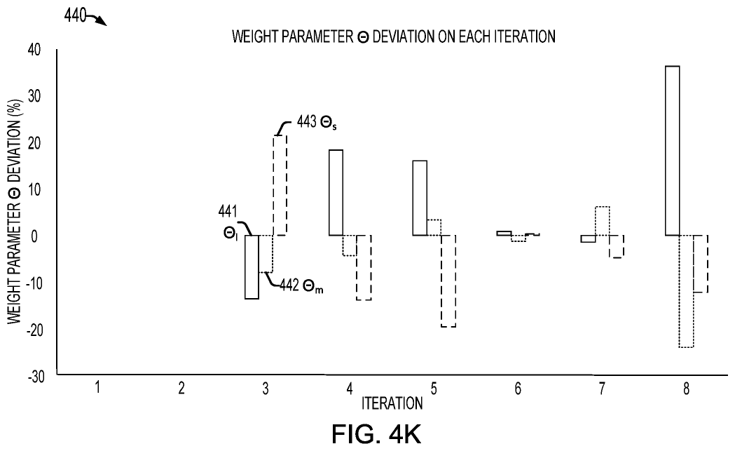

Referring also to FIGS. 4A-4K, FIG. 4A shows a graph 400 of lab collected on-state resistance (Rdsₒₙ) MOSFET aging data in ohms (Ω), for example, in use of a monitored MOSFET in a switching rectifier 130 and/or inverter 150 in the motor drive industrial system 100 of FIG. 1 as a function of time. The graph 400 includes a first curve 401 showing peaks and valleys of the on-state resistance of the component, and a second curve 402 that shows the filtered on-state resistance of the monitored component as a function of time. A graph 406 in FIG. 4B includes a curve 408 that illustrates derived MOSFET reliability based on collected data (e.g., as a percentage of remaining life) as a function of time over a range corresponding to the on-state resistance graph 400 of FIG. 4A. The curve 408 illustrates the gradual decline in the reliability estimate (e.g., computed R(t) above), and the processor 114, 172 compares the value of the curve 408 with the reliability threshold (e.g., RTH in FIG. 2 above).

FIGS. 4C-4J include respective graphs 410, 420, 422, 424, 426, 428, 430, and 432 of MOSFET reliability estimates (e.g., computed R(t)) for an example prognostic model program with weighting vector parameters individually associated with three respective predictors of different long, medium and short durations for eight example step iterations. The graphs 410, 420, 422, 424, 426, 428, 430, and 432 include training data points 411, future data points 412, a long-window trained curve 413, a medium-window trained curve 414, a short-window trained curve 415, a long-window predicted reliability curve 416, a medium-window predicted reliability curve 417, a short-window predicted reliability curve 418, a combined predicted reliability curve 419, and a combined predicted 95% confidence interval window 420. FIG. 4K shows a graph 440 with bar chart deviation percent representations 441, 442, and 443 for the respective long, medium, and short-window weighting vector deviation values Θ₁, Θₘ, and Θₛ in the eight respective update step iterations. The graph 440 shows deviation of calculated value from 1/N (e.g., N=3 here) in %, as calculated by equation (4) above. In this example, the deviations in the first two iterations are zero, but thereafter, the weighting vector parameters θi are updated (e.g., at 204 in FIG. 2 above) as the algorithm progresses through successive update steps j. The simulation examples illustrate the ability of the short-window predictor to respond quickly to changes. The illustrated examples provide adaptive reliability estimation updating through weighting vector parameter updates to better estimate the actual remaining life reliability of a given modeled component of the industrial system 100. The system adapts to operating condition changes through lifetime (e.g., temperature, power supply, load, voltage, humidity, operating frequency, etc.), and selectively provides alarms or warnings as well as data that can be evaluated by a hierarchical system (e.g., in a connected network device 110) for preventive system check and maintenance, especially when accelerated degradation is detected. The disclosed examples can improve reliability prediction capability and facilitate extension of system lifetime while mitigating unexpected downtime. The system and methods described in the above examples can be used in any motor drive products and other hardware products or industrial system apparatus generally to help lower maintenance cost and potentially improve product lifetime.

Various embodiments have been described with reference to the accompanying drawings. Modifications and changes may be made thereto, and additional embodiments may be implemented, without departing from the broader scope of the invention as set forth in the claims that follow. The specification and drawings are accordingly to be regarded in an illustrative rather than restrictive sense. The above examples are merely illustrative of several possible embodiments of various aspects of the present disclosure, wherein equivalent alterations and/or modifications will occur to others skilled in the art upon reading and understanding this specification and the annexed drawings. In addition, although a particular feature of the disclosure may have been disclosed with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising”.

While some examples provided herein are described in the context of an embedded prognostic model program 180 and execution thereof by an embedded processor 172, the reliability estimation systems and methods described herein are not limited to such embodiments and may apply to a variety of other reliability estimation environments and their associated systems. One or more aspects of the described examples may be embodied as a system, method, computer program product, and other configurable systems, including non-transitory computer readable mediums with computer-executable instructions for implementing the described methods. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more non-transitory computer readable medium(s) having computer readable program code embodied thereon.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above description using the singular or plural number may also include the plural or singular number respectively. The word “or” in reference to a list of two or more items, covers all of the following interpretations of the word: any of the items in the list, all of the items in the list, and any combination of the items in the list.

The following is claimed:

1. An industrial system, comprising:
an inverter having an output configured to drive a motor load;
an electronic memory that stores data and program instructions; and
a processor configured to execute the program instructions to control the inverter, estimate a reliability of a component of the industrial system using a prognostic model program, update weighting vector parameters of the prognostic model program based on collected data and a previous reliability estimate using machine learning, and selectively generate a warning based on comparison of the reliability with a threshold.

2. The industrial system of claim 1, wherein the processor is configured to update the weighting vector parameters of the prognostic model program by a root mean square error algorithm.

3. The industrial system of claim 1, wherein the weighting factor parameters of the prognostic model program are individually associated with a respective predictor of the reliability of the component of the industrial system.

4. The industrial system of claim 3, wherein the weighting factor parameters of the prognostic model program are of different operating durations of the component of the industrial system.

5. The industrial system of claim 3, wherein the weighting factor parameters of the prognostic model program are of different operating frequencies of the component of the industrial system.

6. The industrial system of claim 3, wherein the weighting factor parameters of the prognostic model program are of different operating temperatures of the component of the industrial system.

7. The industrial system of claim 3, wherein the weighting factor parameters of the prognostic model program are of different operating voltages of the component of the industrial system.

8. A method, comprising, in individual ones of successive update steps:
using a processor, estimating a reliability of a component of an industrial system using a prognostic model program;
using the processor, updating weighting vector parameters of the prognostic model program based on collected data and a previous reliability estimate using machine learning; and
using the processor, selectively generating a warning based on comparison of the reliability with a threshold.

9. The method of claim 8, further comprising:
using the processor, is updating the weighting vector parameters of the prognostic model program by a root mean square error algorithm.

10. The method of claim 8, wherein the weighting factor parameters of the prognostic model program are individually associated with a respective predictor of the reliability of the component of the industrial system.

11. The method of claim 10, wherein the weighting factor parameters of the prognostic model program are of different operating durations of the component of the industrial system.

12. The method of claim 10, wherein the weighting factor parameters of the prognostic model program are of different operating frequencies of the component of the industrial system.

13. The method of claim 10, wherein the weighting factor parameters of the prognostic model program are of different operating temperatures of the component of the industrial system.

14. The method of claim 10, wherein the weighting factor parameters of the prognostic model program are of different operating voltages of the component of the industrial system.

15. A non-transitory computer readable medium with computer executable instructions which, when executed by a processor, cause the processor to:
estimate a reliability of a component of an industrial system using a prognostic model program;
update weighting vector parameters of the prognostic model program based on collected data and a previous reliability estimate using machine learning; and
selectively generate a warning based on comparison of the reliability with a threshold.

16. The non-transitory computer readable medium of claim 15, further comprising computer executable instructions which, when executed by the processor, cause the processor to:
update the weighting vector parameters of the prognostic model program by a root mean square error algorithm.

17. The non-transitory computer readable medium of claim 16, wherein the weighting factor parameters of the prognostic model program are individually associated with a respective predictor of the reliability of the component of the industrial system.

18. The non-transitory computer readable medium of claim 16, wherein the weighting factor parameters of the prognostic model program are of different operating durations of the component of the industrial system.

19. The non-transitory computer readable medium of claim 16, wherein the weighting factor parameters of the prognostic model program are of different operating frequencies of the component of the industrial system.

20. The non-transitory computer readable medium of claim 16, wherein the weighting factor parameters of the prognostic model program are of different operating temperatures of the component of the industrial system.
